(19) United States
(12) Patent Application Publication
(10) Pub. No.: US 2009/0292550 A1
(43) Pub. Date: Nov. 26, 2009

(54) METHOD FOR CALCULATING THE OPTIMAL TIMES FOR AN EVENT

(76) Inventor: Eric Ly, Mountain View, CA (US)

Correspondence Address: SCHOX PLC, 500 3rd Street, Suite 515, San Francisco, CA, 94107, US

(21) Appl. No.: 12/471,460

(22) Filed: May 25, 2009

Related U.S. Application Data
(60) Provisional application No. 61/055,754, filed on May 23, 2008.

(51) Int. Cl. G06Q 99/00; G06N 5/02

(52) U.S. Cl. 705/1; 706/47

(57) ABSTRACT

A method for planning an event with a computer system that includes the steps of gathering the constraints, creating filtered layers based on the constraints, intersecting at least two filtered layers, and determining at least one optimal time for the event. In another preferred embodiment, the method for planning an event includes the steps of gathering the constraints, creating filtered layers based on the constraints, intersecting at least two filtered layers, and determining at least one set of event details.

### CROSS-REFERENCE TO RELATED APPLICATIONS

This application claims the benefit of U.S. Provisional Application No. 61/055,754 filed 23 May 2008, which is incorporated in its entirety by this reference.

### TECHNICAL FIELD

This invention relates generally to the event planning field, and more specifically to a new and useful method in the event planning field.

### BACKGROUND

Scheduling an event involving multiple parties is a complicated problem. People have different schedules, preferences, and priorities. Even with a limited scope in the number of factors, people must spend a considerable amount of time communicating between event invitees and then making a judgment decision to determine the details of the event. Often, people only take into consideration time availability in participants established calendars, and it is seemingly impossible to consider travel time, attendance records, and numerous other factors that would be beneficial (yet impractical to consider). Thus, there is a need in the event planning field to create a new and useful method of planning an event. This invention provides such a new and useful method

### BRIEF DESCRIPTION OF THE FIGURES

FIG. 1 is a flowchart representation of a first preferred method of the invention.

FIG. 2 is a flowchart representation of a second preferred method of the invention.

FIG. 3 is an exemplary algorithmic flowchart representation of the calculation steps of the preferred methods of the invention.

FIG. 4 is a continuation of the exemplary algorithmic flowchart representation of FIG. 3.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. First Embodiment of the Invention

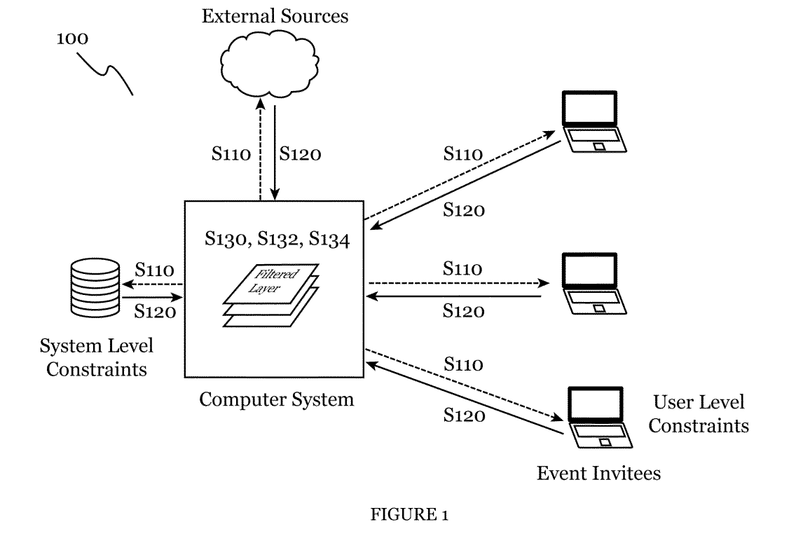

According to the first preferred embodiment, as shown in FIG. 1, the method 100 of calculating the optimal times for an event includes gathering the constraints S120, and calculating the optimal times for an event S130 that includes creating filtered layers, intersecting at least two filtered layers, and determining the optimal time. The invention is preferably used to schedule the optimal time of an event using constraints and preferences of event participants, but may alternatively be used to schedule repeating events or any other type of event (or events) in any appropriate environment for any appropriate reason. In another embodiment, the method may be used to plan any suitable detail of an event such as time, attendees, location, venue (restaurant, food, etc), or any suitable detail of an event. The method is preferably performed by a software program running on a computer system (or multiple systems) and more preferably is a web application running on a server, but may alternatively be performed by any suitable system. The method is preferably used within a calendaring system used for scheduling events. By gathering constraints for each event individually, an optimized time is found for individual events. Unwanted free time is preferably eliminated from consideration and other constraints may additionally be considered in the calculation of the optimized time, such that events are planned not based on established events but by event constraints specific for an event.

An initial optional step of choosing the constraints S110, functions to enable the selection of user level, system level, and/or other suitable constraints for an event. The constraints preferably establish a preference for details of the event according to a source (such as a user or the system). The constraints used in the method are preferably either preferred constraints or required constraints. The preferred constraints are preferably used to indicate preference for an event time or detail (similar to a vote or a rating). A required constraint is preferably a constraint that must be satisfied or is pre-set for the event. For example, an event planner may create a required constraint that more than 75% of the invitees must attend. The preferred constraints and required constraints are preferably describable as user level constraints and/or system level constraints. User level constraints preferably include: available time slots or time ranges, preferred time slots or time ranges, the number of breakfast/lunch/dinner meetings per day (preferably only one lunch is scheduled per day, but multiple lunches, such as a brunch and late lunch may also be options), and consideration of auxiliary schedules (such as friend or family member schedules like children's sports schedules or recitals). In this list available time slots may be used as a required constraint and preferred time slots may be used as a preferred constraint. System level constraints preferably include required key participants to the event (e.g., “all board members” or “all band members”), required attendance percentage of invitees (e.g., “90% of shareholders” or “67% of the Senate”), requirement of attendance percentage of a sequence of events (e.g., “80% of the class seminars”). The system level constraints may additionally include any constraints based on stored information such as past event information. Constraints may alternatively be any suitable constraint such as outside information such as weather, or other calendar schedules.

Step S120 recites gathering constraints functions to obtain data for the chosen constraints. The constraints for the event are preferably gathered from at least one participant (an event invitee) but may alternatively be supplied by an event planner, an event organizer(s), the system or any suitable source. The constraints are preferably time constraints gathered from event invitee calendars, event invitee geographic locations, event invitee statuses, event invitee routines, event invitee travel routes, event invitee dining restrictions (e.g., vegetarian, kosher, no-pork, or wheat allergy), event invitee dining preferences (e.g., Indian, Thai, or Burgers and Fries), event invitee seating preferences, event invitee capital requirements, event invitee assignment completion requirements, event invitee attendance records, or any other suitable constraint.

In one variation of step S120, additional external constraints (preferably defined to be constraints that are not directly related to the event invitees) may be gathered, such as project completion rates, projected project completion times, travel times between geographic locations, event location costs, school schedules, sporting event schedules, TV schedules, religious events, community events (such as festivals), business hours of a event location, telephone peak rates, water usage peak rates, electricity usage peak rates, weather forecasts, financial indicators, hotel vacancies, or any other suitable external constraint.

In another variation of step S120, the constraints may also be gathered from additional calendars of entities associated with an event participant, such as the calendars of relatives (such as a spouse and/or children). Additionally, other events may be prioritized (such as a school recital or a championship sporting event) on these related calendars, and/or a requirement to attend 80% of a relative's events, such as sporting events in a season (resulting in a higher priority to attend an event as events in the series are missed).

In yet another variation of step S120, a weather forecast is gathered, for example, a picnic may be scheduled for outdoors if the weather is sunny and may be cancelled, rescheduled, or held in an alternate location if it is raining.

In another variation of step S120, other event details for an invitee may also be gathered from past or current events. The past or current events preferably provide constraint information for event patterns such as attendance percentage for a category of events, preferred times for events, occurrence of rescheduling, and/or any suitable history information.

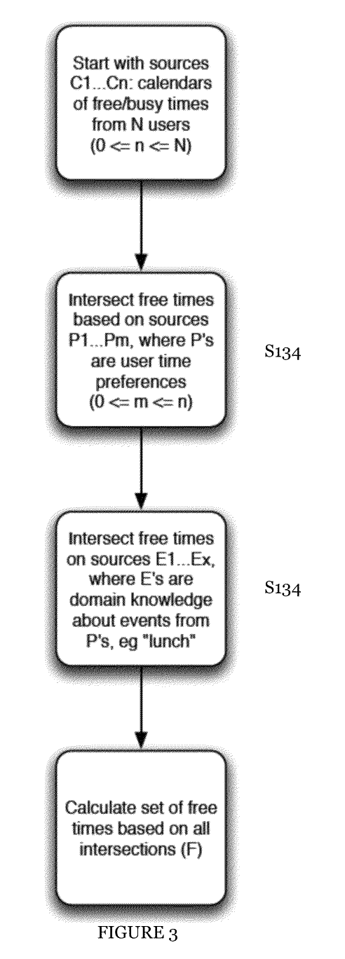

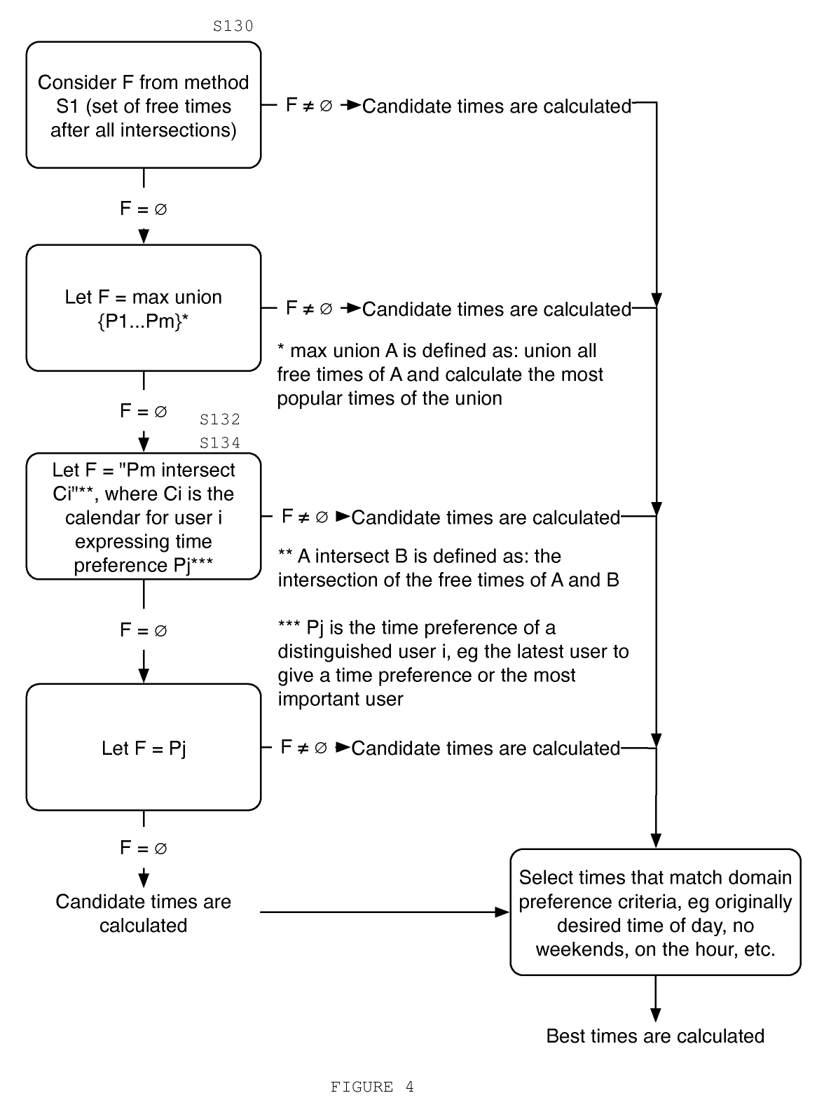

Step S130, which recites calculating the optimal times for an event, preferably functions to calculate at least one optimized time for an event, and more preferably functions to calculate multiple optimized times for an event. Step 130 preferably also includes selecting one or multiple optimized discrete times and/or time ranges as the optimal time for an event. The optimized time preferably is a time that satisfies a significant number of constraints but is preferably not limited to satisfy all constraints. In other words, the calculation maximizes the amount of compliance with the constraints. Step S130 preferably includes creating filtered layers from the constraints S132 and intersecting at least two filtered layers S134. The calculations are preferably constrained to meet at least one goal for the event planning, such as minimizing travel time to the event, maximizing event attendance, minimizing cost, or any other suitable optimization goal. In a preferred variation of the method, the optimal time is selected to maximize the maximum number of event participants by using a layered approach as shown in FIGS. 3-4. The layered approach preferably uses the intersection of various filtered layers to find optimal time(s) for an event. A filtered layer is preferably a software construct that describes the preferences for an event based on the constraints used as a “filter”. The filtered layer preferably uses a gradient or range of values to describe a metric of preference, but the filtered layer may alternatively or additionally have a binary state (i.e., free time and non-free time) or any suitable system for documenting preference/availability levels. A filtered layer is preferably a list of free times that have been filtered by at least one constraint (or alternatively calculated from or related to a constraint). A filtered layer may alternatively be a list of locations, businesses, meeting topics, activities, or any suitable event related detail. The layered approach may be used in an iterative process to maximize the degree to which goals may be satisfied. In one variation, a user level optimal time may be formed from intersecting multiple filtered layers (the filtered layers are preferably associated with user level constraints and more preferably each user has an associated filter layer). A system level optimal time may be formed from system level constraints. An optimal time(s) is preferably found from the intersection of the user level time(s) and the system level time(s). Preferred constraints are preferably used to weight event options in a filtered layer. The layered approach may include prioritizing certain participants in order of importance (such as prioritizing certain shareholders of a company by the order of their ownership stake) or any other suitable method. The layered approach additionally may be used to handle multiple inputs or constraints provided by a single user, preferably by weighing most recent inputs greater than previous inputs.

As shown in FIG. 3, the calculation of the optimal times for an event preferably includes determining free times based on calendar data of free and busy times for a plurality of users. Any subset of users' input or constraints (a filtered layer) may be considered for the calculation of an optimal time. Not all inputs must be considered, such as in one example where the most recent user input is preferably prioritized more than other user inputs. In this example, the inputs are preferably satisfied in the order of input until not all inputs may be satisfied. More preferably, the calculation includes filtering the free times by user preferences (such as preferred free time), and still more preferably, the calculation includes filtering preferred free times by external domain knowledge, such as events (lunch happens once per day) and locations (there can only be one meeting in the conference room at a time).

As shown in FIG. 4, using the free times filtered by user preferences and external domain knowledge, if no free times are found that accommodate all event participant preferences, then the preferences are maximized to meet the preferences of the maximum number of event participants. If at least one free time is still not determined, the event participants may receive a weighting assigned to their preferences, such that more important event participants (which may include the order in which participants register their preferences) are accommodated before less important event participants, which in the most extreme case, defaults to the best times for the most important event participant. Any suitable hierarchy and/or order of various optimal event conditions may alternatively be used to find a candidate time. Finally, after at least one candidate time is calculated from the calendar data, then the calculated candidate times that match the system level constraints (such as time of day, no weekends, on the hour, etc.) are chosen as the optimal times for the event.

### 2. Second Embodiment of the Invention

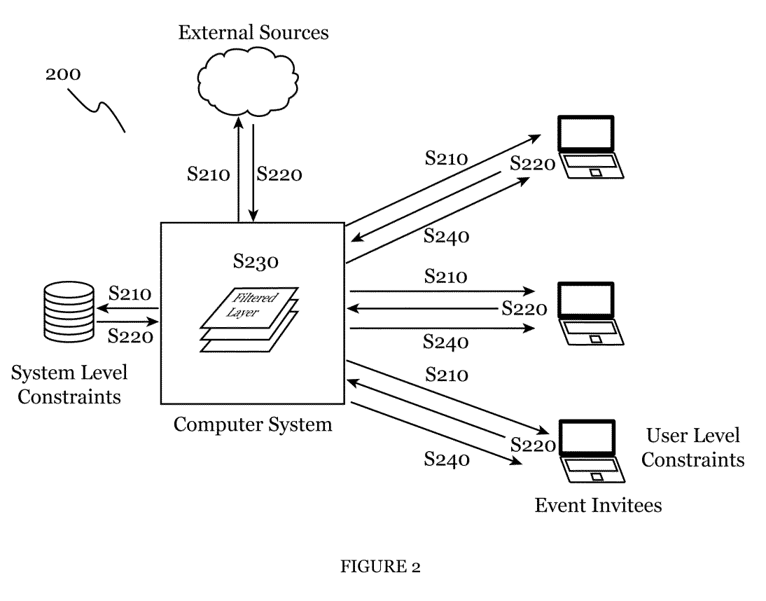

According to the second preferred embodiment, as shown in FIG. 2, the method 200 of calculating the optimal times for an event includes sending an event invite to event invitees S210, gathering the responses of event invitees S220, calculating a optimal time for the event based on the responses received S230, and notifying event participants of the event time S240. The invention is preferably used to schedule events and invite entities (such as people or organizations) to an event, but may alternatively be used to in any appropriate environment for any appropriate reason.

Step S210, which recites sending an event invite to event invitees, functions to inform the invitees of an invitation to an event. The event invite is preferably sent by a particular person or persons (e.g., an “event planner”), but may be automatically sent based on a pre-programmed schedule or in response to any suitable event/action. The event is preferably a meeting, but may alternatively be a party or any other suitable type of event.

Step S220, which recites gathering the responses of event invitees, functions to gather the responses of multiple event invitee and preferably includes the calendar information and constraints and any other suitable information of each event invitee, such as dietary restrictions, geographic location or location constraints, transportation options or transportation constraints, or any other suitable information. The responses preferably constitute the event preferences of event invitees. Preferably, responses from each event invitee are gathered but a portion, or multiple responses from one event invitee, or any suitable number of responses may alternatively be gathered. In one variation, the event invitees may rank the likelihood of their schedule changing. As an example, the event invitee may state that there is a 20% chance that their availability to attend (or not attend) the event may change (to either not attend or attend). As an addition or alternative, responses may be received from other sources other than event invitees such as from an event planner, an event organizer(s), the system, and/or any suitable source.

Step S230, which recites calculating a optimal time for the event based on the responses received functions to utilize the calendar information and any other suitable information to choose at least one optimal time for the event, and is calculated similar to the calculation step S130 above (and exemplified in FIGS. 3-4). Step S230 may also include at least one additional goal for the event planning, such as minimizing transit time, maximizing attendance, minimizing attendance, minimizing costs, minimizing man-hours, or any other suitable optimization goal. In one variation of Step S230, the event planner may select the optimal time from among at least two optimal times. The event planner in this case acts as a tie-breaker and moderator in the event of equally optimal times.

Step S240, which recites notifying event participants of the event time, functions to notify the event invitees and the event instigator of at least one optimal time, preferably one selected optimal time. The notification is preferably an email, but may alternatively be a text message, a phone call, a website update, a social networking message (such as a LinkedIn, Twitter, Facebook, or Myspace message), a mailing (such as a postcard or brochure), a printable ticket, status on a website, or any other suitable notification.

In one variation of Step S240, the optimal time may change based upon changes of the schedule of at least one event invitee or the event planner, and Step S240 may preferably include notifying all event participants of the schedule change, or any other change to the event, such as a change in location.

In another variation, a history of changes for each event participant may be recorded, and the optimal time may be selected based upon a calculated probability of changes in the history of calendar changes among event participants. For example, if a meeting is frequently cancelled by a particular event participant, or alternatively by a frequently conflicting event, the event notification will include a likelihood score, such as an 80% chance of the event being held at a specified time and location. Further the likelihood score could be concluded from weather conditions, such as an 80% chance of rain. Additionally, history information for other events may be incorporated into the calculation of the optimal time.

As a person skilled in the art will recognize from the previous detailed description and from the figures and claims, modifications and changes can be made to the preferred embodiments of the invention without departing from the scope of this invention defined in the following claims.

I claim:

1. A method of scheduling an event with a plurality of invitees from a computer system comprising:
gathering constraints for the scheduling of the event, the constraints including preferred constraints and required constraints;
creating filtered layers based on the gathered preferred constraints and required constraints;
intersecting at least two filtered layers; and
determining at least one optimal time for the event.

2. The method of claim 1, wherein a filtered layer is a construct that describes preferred times of the event that is defined by the constraints of a filter.

3. The method of claim 2, wherein a filtered layer is created for each invitee.

4. The method of claim 2, wherein a preferred constraint is a weighted event option used to adjust the preference of a time in a filtered layer and a required constraint is a set event detail.

5. The method of claim 4, wherein a required constraint is event attendance percentage.

6. The method of claim 4, wherein the intersection of at least two layers creates a preference metric of times for the event.

7. The method of claim 6, wherein the preference constraints add a weighting factor that affects the preference metric of times for the event.

8. The method of claim 7, wherein the preferred constraints are preferred time options gathered from an event invitee.

9. The method of claim 7, wherein the preferred constraints are location information used to calculate travel time.

10. The method of claim 7, wherein the preferred constraints and required constraints are gathered from the event invitees and the computer system.

11. The method of claim 4, wherein the steps of gathering constraints and intersecting filtered layers include:
gathering calendars of free time of the event invitees, preferred times of invitees, domain knowledge from the system; and
intersecting the calendars, the preferred times, and the domain knowledge.

12. The method of claim 4, wherein the step of creating a filtered layer includes:
using a first set of desirable constraints in the creation of the filtered layers; and
if after intersecting no free times are found, creating a filtered layers using a second set of desirable constraints, wherein the second set of constraints is less restrictive than the first set of constraints.

13. A method of planning an event with a plurality of invitees from a computer system comprising:
gathering constraints for the planning of the event, the constraints including preferred constraints and required constraints;
creating filtered layers based on the gathered preferred constraints and required constraints;
intersecting at least two filtered layers; and
determining at least one set of optimal event details.

14. The method of claim 13, wherein a filtered layer is a construct that describes a preferences of event details as defined by the constraints of a filter.

15. The method of claim 14, wherein a preferred constraint is a weighted event option used to adjust the preference of an event detail in a filtered layer and a required constraint is a set event detail.

16. The method of claim 15, wherein the intersection of at least two layers creates a preference metric for optional event details.

17. The method of 15, wherein suggested event details are gathered from event invitees.

18. The method of claim 17, wherein a preferred constraint is gathered from a database of previous preferred constraints.

19. The method of claim 15, wherein event details include event time and location.

20. The method of claim 19, wherein the event details further include event venue and attendees.
